(19) United States
(12) Patent Application Publication
(10) Pub. No.: US 2012/0063045 A1
(43) Pub. Date: Mar. 15, 2012

(54) DETECTING AND SELECTIVELY IGNORING POWER SUPPLY TRANSIENTS

(75) Inventor: William Brandes Shearon, Colorado Springs, CO (US)

(73) Assignee: INTERSIL AMERICAS INC., Milpitas, CA (US)

(21) Appl. No.: 13/093,586

(22) Filed: Apr. 25, 2011

Related U.S. Application Data
(60) Provisional application No. 61/381,529, filed on Sep. 10, 2010.
(60) Provisional application No. 61/413,001, filed on Nov. 12, 2010.

(51) Int. Cl. H02H 3/08

(52) U.S. Cl. 361/65

(57) ABSTRACT

Systems and methods for discriminating a negative-going load fault from a positive-going input voltage (VIN) surge are disclosed. The system includes a circuit that senses the VIN voltage to generate a disable signal, if the positive-going VIN surge is identified. Specifically, the circuit can include a high pass filter to facilitate identification of the positive-going VIN surge. Moreover, the disable signal is employed to control an overcurrent comparator that provides an overcurrent shut-off. Typically, when the positive-going VIN surge is identified, the disable signal is generated, which masks the overcurrent response, such that, normal operation can be continued without erroneously shutting-off the load.

### CROSS REFERENCE TO RELATED APPLICATIONS

This application claims priority to U.S. Provisional Patent Application Ser. No. 61/381,529, filed on Sep. 10, 2010 (Attorney docket number SE-2848-IP/INTEP112US), and entitled “A CIRCUIT TO DETECT AND IGNORE POWER SUPPLY TRANSIENTS IN AN INTEGRATED CIRCUIT (IC) CIRCUIT BREAKER.” This application also claims priority to U.S. Provisional Patent Application Ser. No. 61/413,001, filed on Nov. 12, 2010 (Attorney docket number SE-2848-IP/INTEP112USA), and entitled “A CIRCUIT TO DETECT AND IGNORE POWER SUPPLY TRANSIENTS IN AN INTEGRATED CIRCUIT (IC) CIRCUIT BREAKER”. Each of these applications is incorporated herein by reference in its entirety.

### BRIEF DESCRIPTION OF THE DRAWINGS

The numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates high-level functional blocks for an example architecture, according an embodiment of the subject innovation;

FIG. 2 illustrates an example implementation for a power supply positive transient detector;

FIG. 3 illustrates another example implementation for a detector that identifies positive transients associated with power supply voltage;

FIG. 4 illustrates an example implementation for a voltage spike detector that differentiates between a positive surge on an input voltage and a load voltage failure condition;

FIG. 5 illustrates an example redundant power system that employs a power supply sensing and overcurrent-masking feature;

FIG. 6 illustrates an example high level diagram of a redundant power system in a server;

FIG. 7 illustrates an exemplary methodology for identifying a true fault condition in circuit breakers, according to an embodiment of the present invention

FIG. 8 illustrates an exemplary methodology for selectively disconnecting a circuit upon identifying a true fault condition; and

FIG. 9 illustrates an example electronic system that utilizes a positive transient detector for power supply sensing and overcurrent-masking.

### DETAILED DESCRIPTION

The subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the subject matter may be practiced without these specific details. In some instances, structures and devices are shown in block diagram form in order to facilitate describing the embodiments of the subject innovation.

Moreover, the word “exemplary” is used herein to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, the word “coupled” is used herein to mean direct or indirect electrical or mechanical coupling.

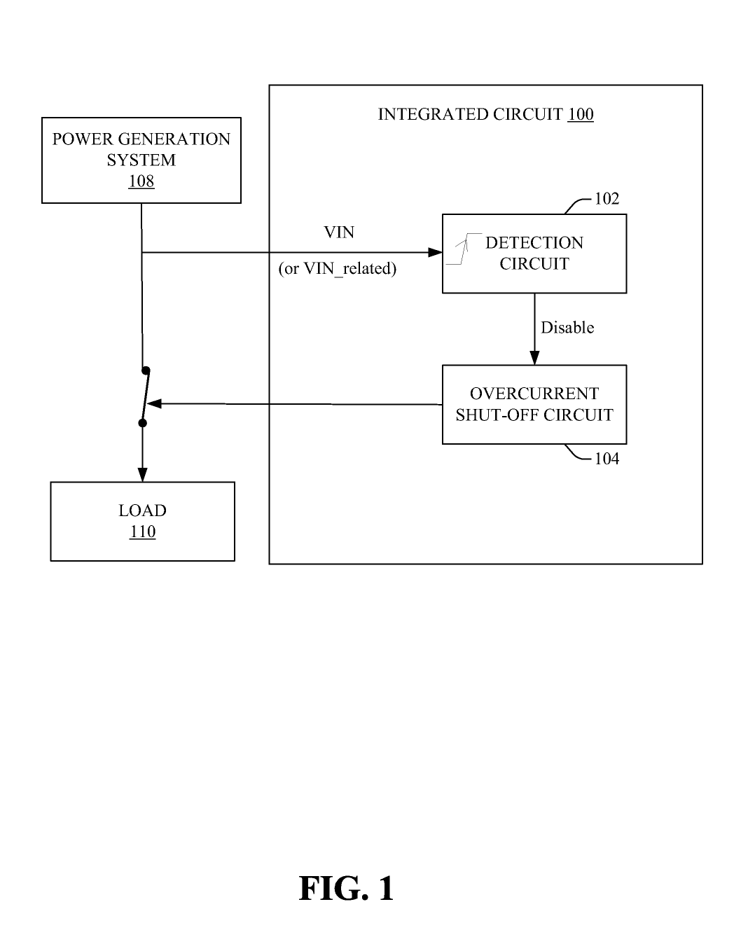

Referring to FIG. 1, there illustrated is an example system that includes integrated circuit (IC) 100 for masking voltage supply transients of a power generation system 108, according to an aspect of the subject disclosure. In particular, the IC 100 facilitates detection and selective rejection of a power surge, which is a temporary rise in voltage and/or current in an electrical circuit. Small voltage transients are a common power problem and even if they do not cause electrical damage to equipment, they can trip overload detection circuits and unnecessarily shut down a computer or server. Shutdown of a computer is a costly event for an end customer because of loss of data and/or loss of productivity. Therefore, computer uptime is a vital feature of large computer systems. As computer power trends toward higher currents and cost pressure motivates reduced copper in computer power bussing, the occurrence and magnitude of transients significantly increases. This is a rapidly growing problem. Aspects disclosed herein utilize an IC 100 that enables surge detection and rejection that can be utilized in various applications, such as, but not limited to, circuit breakers (e.g., hot plug circuit breakers) and/or most any electrical fuses. Hot plug circuit breakers are employed by various systems, for example, distributed power systems, high availability servers (e.g., Telecommunication servers), disk arrays, powered insertion boards, etc. In one aspect, IC 100 can be employed to limit inrush current and offer short circuit protection that eliminates costly downtime due to overloads or short circuits at the load 110. As an example, load 110 can be, but is not limited to a memory system (e.g., disk arrays).

As an example, IC 100 can be utilized within a hot plug controller that is utilized to control inrush currents during turn-on periods and to restrain load currents to safe pre-determined levels in the event of overload current faults during static operations. Moreover, overload faults are triggered when the downstream loads short-circuit. The fault shuts off the switch removing the overload current and thereby disconnecting the load from the supply voltage. However, sometimes an overload current is not caused by load failure, but rather is generated by upward spikes or surges of input voltage (VIN) (e.g., supply voltage generated by power generation system 108). Such a voltage spike can result in a huge current passing harmlessly into the load capacitors. Although the above scenario is a true overcurrent condition, the overload is not caused by a faulty load, and thus it is inappropriate to shut-off the load. The IC 100 discriminates between a downward load fault and an upward VIN surge and generates a signal to momentarily/temporarily mask the overcurrent response, if an upward VIN surge is detected.

In one embodiment, IC 100 is employed to detect an overload condition due to a positive surge voltage and/or poor voltage regulation on input voltage VIN (e.g., supply voltage). Typically, a positive surge voltage is a temporary/instantaneous rise in voltage (δv) in a short time period (δt). Generally, overload conditions can occur due to various factors, such as, but not limited to, short-circuit of a load (e.g., true fault condition) or upward spikes or surges in VIN. The IC 100 prevents the inappropriate (or premature) activation of the overcurrent shut-off circuit 104, which would remove the overload current from the load 110 in all the overload conditions, regardless of whether a true fault condition occurred or not. The IC 100 employs a detection circuit 102 to differentiate between a positive surge voltage (and/or poor voltage regulation) on VIN and a load voltage collapse (e.g., a true fault condition), such that the load can be switched off only in case of a load voltage collapse. In an aspect, during overload, the detection circuit 102 produces an output signal (e.g., disable signal), which indicates that the overload condition arose due to a positive surge voltage (and/or poor voltage regulation) on VIN. The detection circuit 102 can additionally or alternately, output a signal, which indicates that an overload condition arose due to a true fault condition (e.g., enable signal).

As an example, the detection circuit 102 senses a VIN or a VIN related node, which is coupled to the load 110, and differentiates between a positive surge and a negative surge on the VIN or the VIN related node. Moreover, detection circuit 102 masks the response of an overcurrent shut-off circuit 104 only on detecting a positive surge. It can be appreciated that the detection component 102 can employ most any circuit that identifies the positive surge voltage and/or poor voltage regulation on VIN. Moreover, the detection circuit 102 can output a disable signal, which masks (e.g., blocks) the output signal generated by the overcurrent shut-off circuit 104, if the positive surge voltage and/or poor voltage regulation is identified. As an example, the disable signal can be “HIGH” when positive surge voltage and/or poor voltage regulation is detected and be “LOW” when a true fault condition is detected (e.g., faulty load). Accordingly, the detection circuit 102 provides high pass, positive-transient-only masking of overcurrent or short circuit detection.

Furthermore, the overcurrent shut-off circuit 104 can be utilized to trip the load 110 when an overcurrent is detected. Based on the Disable signal received from the detection circuit 102, the overcurrent shut-off circuit 104 turn off/disconnect the load 110 only on detection of a true fault condition. It can be appreciated that, the detection circuit 102 and the overcurrent shut-off circuit 104 can include electrical circuit(s) having components and circuitry elements of any suitable value in order to implement the embodiments of the subject innovation. Furthermore, although the detection circuit 102 and the overcurrent shut-off circuit 104 are depicted to reside within a single IC 100, it can be appreciated that the subject innovation is not so limited and that detection circuit 102 and the overcurrent shut-off circuit 104 can be implemented on/reside within multiple IC chips.

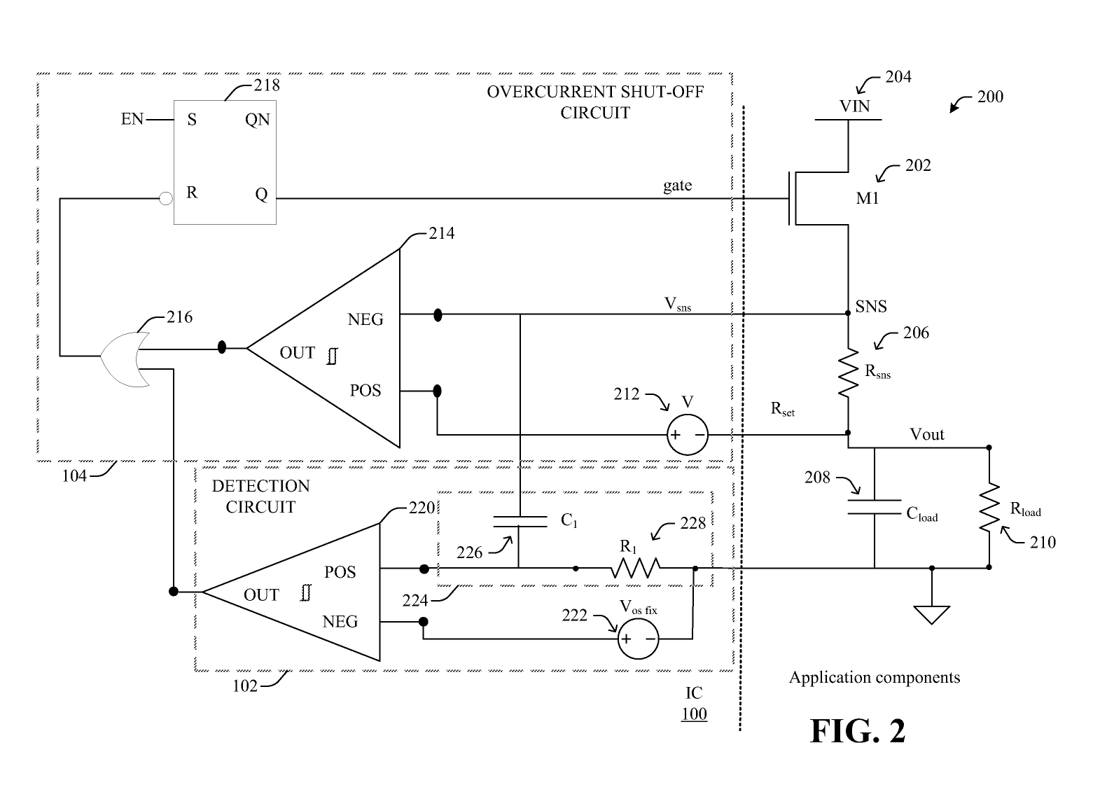

Referring now to FIG. 2, there illustrated is an example circuit diagram 200 that facilitates detection of a positive transient in a signal output by a power supply in accordance with an embodiment of the subject innovation. The circuit 200 includes an n-metal oxide semiconductor field effect transistor (n-MOSFET) (M1) 202, which can be most any high-power MOSFET (1-100 A current), connected to input voltage (VIN) 204. Furthermore, a resistor (Rₛₙₛ) 206, for example, a very high power application resistor (e.g., with resistance of around 5 milliohms or less) is connected between M1 202 and the load. As an example, capacitor (C_{load}) 208 and resistor (R_{load}) 210 are symbolic representations of the load driven by circuit 200. Usually, M1 202, Rₛₙₛ 206, C_{load} 208 and R_{load} 210 are application-side components, for example, part of a customer system, which typically do not reside within the IC 100 that implements the positive transient detector.

In one aspect, during normal operation, output voltage (Vout) is almost equal to VIN 204. Typically, when a high current runs through the Rₛₙₛ 206, a small voltage (Vₛₙₛ) (e.g., 10-30 mV) is developed across Rₛₙₛ 206. However, on failure of the load, for example if the load is short-circuited, the voltage across Rₛₙₛ 206 can substantially increase and become much larger than normal. When Vₛₙₛ increases the IC-side circuit is activated. It can be appreciated that the voltage at VIN 204 can also be sensed instead of sensing voltage (Vₛₙₛ) at sense node (SNS). However, oftentimes, the sense node (SNS) is preferred over the VIN 204 supply pin itself, because, usually, the VIN 204 supply pin can have external filtering to protect it from Electrostatic discharge (ESD) and/or voltage surge. The external filtering can degrade the VIN signal.

When the voltage drop (Vₛₙₛ) across Rₛₙₛ 206 exceeds the preset voltage (V volts), provided by the voltage source 212, the primary comparator 214 can trip, causing the output of the primary comparator to be LOW. As an example, voltage V can be most any predefined outer bounds voltage, e.g., 50-100 mV, and can also be provided by employing a current source with a resistor. The primary comparator output is provided to the input of an OR gate 216, the output of which causes a latch 218 to reset. Although an OR gate 216 is depicted in circuit 200, it can be appreciated that most any logic gate can be utilized. For example, the logic gate can be a NAND, NOR, AND and/or OR by adding or subtracting inverters or switching the comparator inputs. In another example, the latch 218 can include most any flip-flop latch, such as, but not limited to a Set-Reset (SR) latch, that can be implemented by utilizing most any logical gate, for example, NOR gates, NAND gates, etc.

Moreover, the output of latch 218 can be provided to the gate of M1 202, and can switch off M1 202. Thus, in this example scenario, the circuit 200 is disabled on detecting fault condition that is caused due to a faulty load. Alternately, in another aspect, the latch 218 is not utilized and the output of the OR gate 216 can be directly utilized to control the gate of M1 202. It can be appreciated that most any switch/switching circuit (e.g., controlled by the output of the OR gate 216 or latch 218) can be utilized instead of M1 202 to disconnect the circuit 200 and switch off the load. In addition, circuit 200 includes a high pass filter circuit 224, comprised of capacitor (C₁) 226 and resistor (R₁) 228, which detects a fault condition caused by a voltage spike at VIN 204, and prevents M1 202 from being switched off unless a true fault condition has occurred. Typically, the spike can include a positive surge voltage and/or poor voltage regulation and can be caused by various electrical circuits associated with the supply voltage.

During a voltage spike, voltage VIN 204 can increase instantaneously, for example, by δv volts. Moreover, Vout, which is held at the previous value of VIN, cannot change immediately/instantaneously, due to C_{load} 208. Thus, the spiked voltage (δv) at VIN is dropped through the small effective resistance of M1 202, and the resistance of Rₛₙₛ 206 (and parasitic resistance of C_{load} 208). Accordingly, a high voltage (e.g., greater than V volts) is developed across Rₛₙₛ, which can cause the primary comparator 214 to trip. However, in this scenario (e.g., wherein the rise is voltage across Rₛₙₛ 206 is due to a spike in voltage at VIN 204), the instantaneous rise in voltage (δv), is sufficient to overcome the offset voltage (V_{os fix}) generated by voltage source 222, and can also cause the secondary comparator 220 to trip. As an example, V_{os fix} is small fixed voltage that overcomes the natural offset voltage in the secondary comparator 220, such that it pushes the trip point away from zero and the secondary comparator 220 does not trip based on noise or a negative offset voltage (due to faulty load). Typically, the offset voltage (V_{os fix}) can be larger than the secondary comparator input, plus the height/value of normal supply noise at the sense node (SNS), which can be ignored. The offset voltage (V_{os fix}) can be generated by utilizing a current source with a resistor.

According to an aspect, the high pass filter 224 connects to a fixed reference voltage V_{ref} (e.g., ground) and the high pass filter output is compared to the small offset voltage V_{os fix}. Moreover, when a positive surge voltage appears at Vₛₙₛ, an instantaneous voltage offset replica appears at the non-inverting input of the secondary comparator 220, causing it to trip. In one aspect, when the secondary comparator 220 trips, the output of the secondary comparator 220 is HIGH, and thus, the OR gate 216 sends a HIGH signal to the latch 218. Moreover, even though the output at the primary comparator 214 is LOW (due to the high voltage across Rₛₙₛ), the LOW signal is blocked at the OR gate 216 and does not make it to the latch 218. Accordingly, the latch 218 is not reset and M1 202 remains enabled. In contrast, when an overload or short circuit appears at the load (e.g., a true fault condition), the voltage across Rₛₙₛ 206 will increase, but the voltage on Vsns will fall because of the Mosfet M1 resistance (rds(on)) plus any impedance from the VIN supply itself. Moreover, the falling voltage, Vₛₙₛ, can cause a falling voltage at the non-inverting input of the secondary comparator 220. Accordingly, the secondary comparator 220 can maintain the LOW output, which is provided to the input of the OR gate 216. In this case, when the primary comparator 214 trips, it provides a LOW output to the OR gate 216, which is then provided to reset the latch 218 and disable M1 202. Accordingly, circuit 200 is correctly and accurately disabled only for a faulty load conditions.

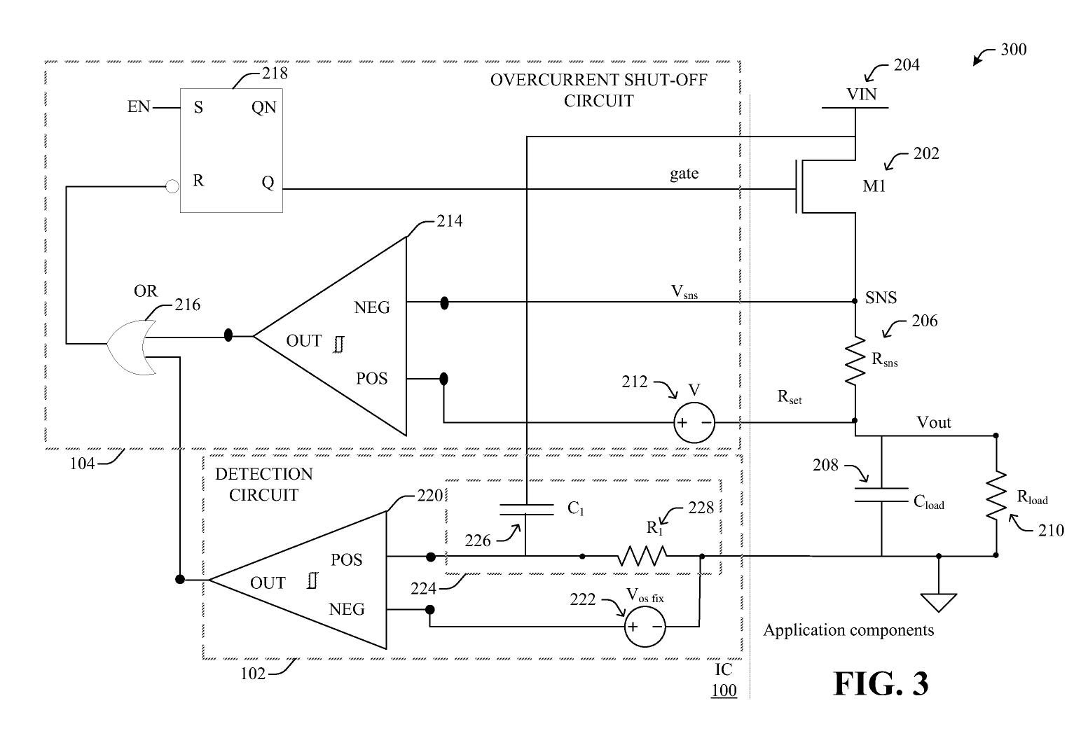

Referring now to FIG. 3, there illustrated is another example circuit diagram 300 for implementing a detector that identifies positive transients associated with power supply voltage, according to an aspect of the subject disclosure. Circuit 300 is similar to circuit 200, explained above, except that the capacitor C₁ 226 for the high pass filter 224 (in the detection circuit 102) is connected directly to VIN 204. Circuit 300 can be preferred over circuit 200 if a clean (e.g., non-noisy) signal is received at VIN 204. The detection circuit 102, overcurrent shut-off circuit 104, M1 202, VIN 204, Rₛₙₛ 206, C_{load} 208, R_{load} 210, voltage source 212, primary comparator 214, OR gate 216, latch 218, secondary comparator 220, offset voltage source 222, high pass filter 224, C₁ 226, and R₁ 228, can include functionality, as more fully described herein, for example, with regard to IC 100 and circuit 200, 300.

In an aspect, when a positive-going transient is observed at VIN 204, both the primary comparator 214 and the secondary comparator 220 will trip. Moreover, the output of the primary comparator 214 will be LOW and the output of the secondary comparator 220 will be HIGH and thus a HIGH signal will be output at the OR gate 216. Accordingly, the latch 218 will not be reset and M1 202 will continue to operate normally, without disconnecting the load. In contrast, if the load is short-circuited, the high voltage generated across Rₛₙₛ 206 will trip the primary comparator 214, leading to a LOW output. Moreover, in this example scenario, the secondary comparator 220 will not trip and its output will also be LOW. Accordingly, the OR gate 216 will output a LOW signal, which will reset the latch 218 and in turn disable M1 202. Thus, the power supply positive transient detector circuit 300 can discriminate positive surge voltage and/or poor voltage regulation on VIN (not a true fault condition), from a load voltage collapse (a true failure condition), and disconnect the load only during a load voltage collapse.

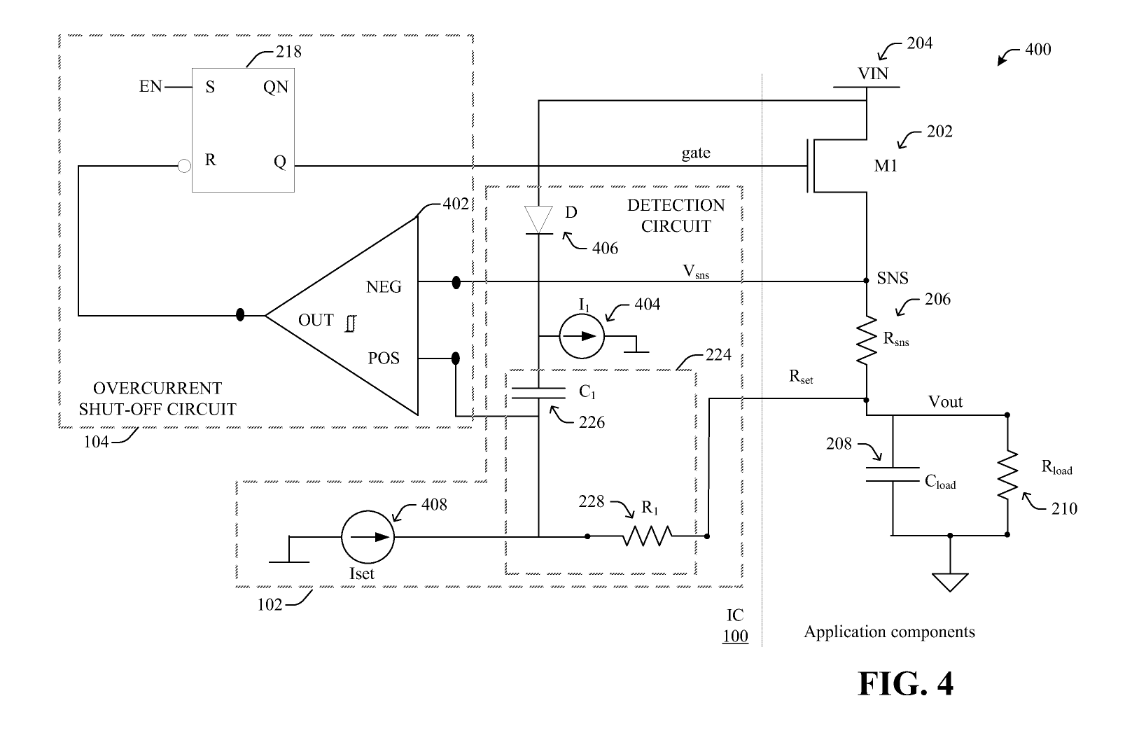

FIG. 4 illustrates yet another example circuit diagram 400 for implementing a voltage spike detector that differentiates between positive surge voltage (and/or poor voltage regulation) on VIN 204, and a load voltage failure condition. The circuit 400 employs a single comparator 402 and utilizes a high pass filter (C₁, R₁) 224 to directly block a signal, due to a positive transient, at the input of the comparator. Moreover, current source Iₛₑₜ 408 and resistor R₁ 228 replaces the voltage source 212, in circuit 200 and 300. In one aspect, Iₛₑₜ 408 and resistor R₁ 228 provide a reference voltage at an input of comparator 402, which is compared with the voltage (Vₛₙₛ) across resistor Rₛₙₛ 206. The capacitor C₁ 226 subtracts the Iₛₑₜ current from I₁ and accordingly the voltage across R₁ 228 is changed. Typically, I₁ is kept substantially lower than Lₑₜ because the value of I₁ reduces (i.e. directly subtracts) accuracy of the reference voltage across R₁ 228. Furthermore, because of the capacitor C₁ 226, a slower response (compared to circuits 200 and 300) can be observed on a real fault (e.g., load voltage collapse). The detection circuit 102, overcurrent shut-off circuit 104, M1 202, VIN 204, Rₛₙₛ 206, C_{load} 208, R_{load} 210, latch 218, high pass filter 224, C₁ 226, and R₁ 228, can include functionality, as more fully described herein, for example, with regard to IC 100 and circuits 200, 300 and 400.

In one aspect, current source I₁ 404 drives a current through the diode D 406, such that, any positive running voltage at VIN 204, shows up immediately and passes through C1 226. Moreover, for a positive spike in VIN 204, there is no voltage barrier to overcome on the diode 406, since the diode 406 is already forward biased. Accordingly, for all positive spikes in VIN 204, the output of the comparator 402 is HIGH, the latch 218 is not reset, and M1 202 operates normally, without disconnecting the load. Alternately, for a load voltage failure condition, the output of the comparator 402 is LOW, which resets the latch 218 and in turn disables M1 202. In this example scenario, as M1 202 is switched off, the load is disconnected for overload protection.

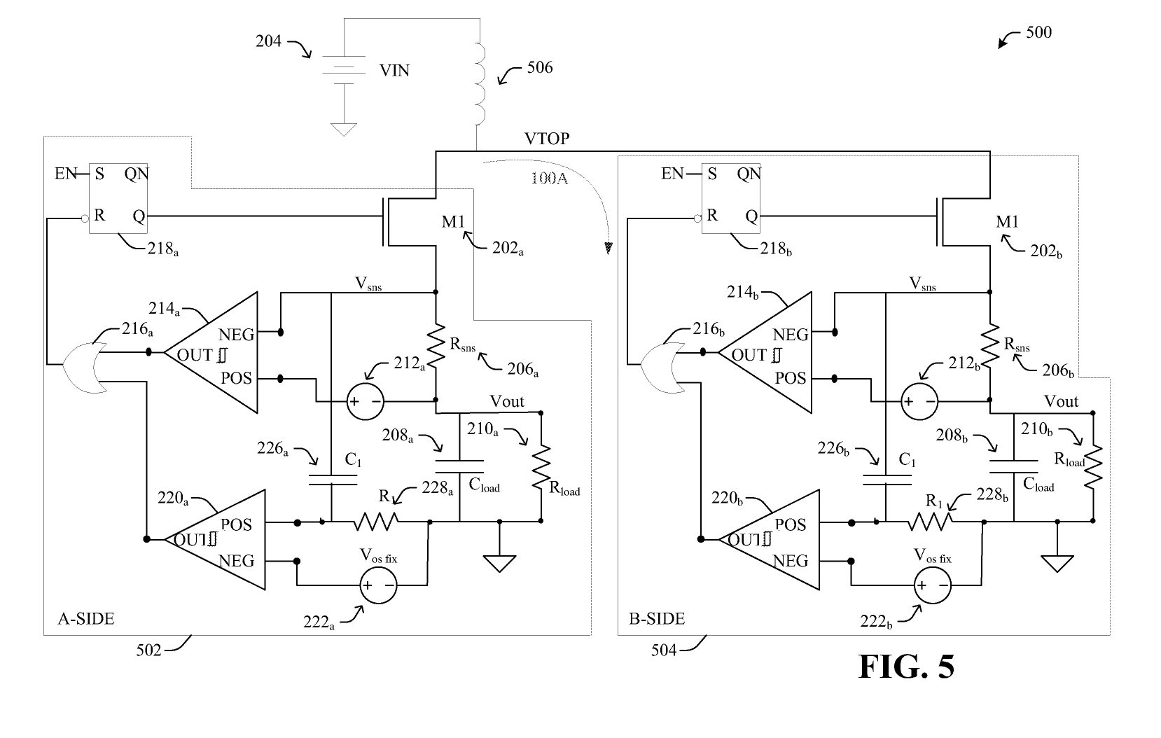

Referring to FIG. 5, there illustrated is an example redundant power system 500 that employs a power supply sensing and overcurrent-masking feature in accordance with an aspect of the subject system. The system 500 can include a redundant system, for example, on a server computer, with two (or more) memory systems, two (or more) disk drives, etc. Moreover, the circuits 502 and 504 in system 500 are set up in parallel, such that, if one circuit (502 or 504) fails, the computer can continue operation by utilizing the other circuit. Thus, constant uptime can be achieved, such that, a failure of one side does not bring down the entire system/network.

Although, two redundant circuits, A-side 502 and B-side 504, are illustrated in FIG. 5, it can be appreciated that the subject disclosure is not so limited and most any number of redundant circuits can be employed. In addition, the A-side 502 and B-side 504 circuits utilize circuit 200 to implement a positive transient detector. However, circuits 300 and/or 400 that discriminate positive surge voltage and/or poor voltage regulation on VIN 204 (not a true fault condition), from a load voltage collapse (a true failure condition) can also be utilized. Both A-side 502 and B-side 504 circuits run the same current, for example, 10 A, for running hard drives.

Consider an example scenario wherein a true fault condition occurs at the load in the B-side circuit 504. For example, the B-side circuit 504 can have a power failure or Vout at the B-side 504 can be shorted, (e.g., Vout is connected to ground or a lower voltage). At this stage, a large voltage is sensed across the B-side Rₛₙₛ 206_{b}, and the overcurrent compensation circuit (e.g., primary comparator 214_{b}, OR gate 216_{b}) can reset the latch 218_{b} and turn off the B-side circuit 504. However, just before the B-side circuit 504 is turned off, a failure current, for example, 100 A, is drawn from VIN 204 by the B-side circuit 504, such that 100 A of failure current flows through the B-side circuit 504 and 10 A of the normal current flows through the A-side circuit 502. Thus, a total current of 110 A flows through the parasitic inductor 506. As an example, the parasitic inductance is caused by a magnetic field generated due to high amounts of current flowing through metal wires/connectors and is symbolically represented as inductor 506. Moreover, since the current through an inductor cannot instantaneously change, the parasitic inductor 506 forces VTOP voltage to spike upward until the magnetic field of the inductor 506 decays. This voltage spike between VTOP and the A-side Vout can create a large voltage across the A-side Rₛₙₛ 206ₐ, after the B-side circuit 504 is switched off.

To avoid the A-side overcurrent breaker, shutting off the A-side 502 and defeating the benefit of the redundant system, the system 500 employs the positive transient detector utilized in the A-side circuit for identifying that the high voltage across the A-side Rₛₙₛ 206ₐ, is caused by a voltage spike in VTOP by tripping both the comparators (214ₐ and 220ₐ) and blocking the latch reset signal at the OR gate 216ₐ. Moreover, since the latch 218ₐ is not reset, M1 202ₐ remains switched on and continues to operate normally, and the A-side circuit 502 is not erroneously shut-off. In this manner, the system can operate normally by employing the A-side circuit 502, without downtime, even if the B-side circuit 504 is shut-off.

The resistors Rₛₙₛ 206, R_{load} 210 and R₁ 228 utilized in circuits 200-500, can have suitable resistance values or ratios depending on the application. Furthermore, capacitors C₁ 226 and C_{load} 208 in circuits 200, 300, 400 and 500 can have suitable capacitance values (or ratios) depending on the application. In one example, the comparators (e.g., primary comparator 214 and/or secondary comparator 220) can include Op-Amps that can be set to provide a specific/maximum gain.

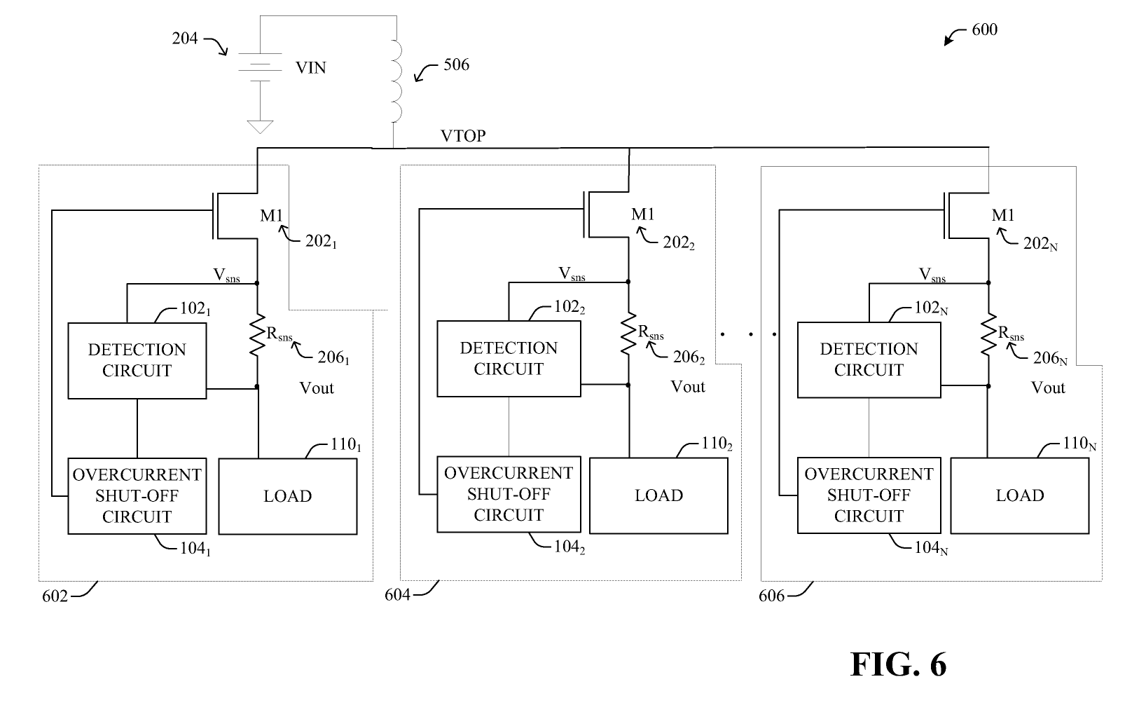

FIG. 6 illustrates a high-level block diagram 600 of the above described redundant power system that utilizes an overcurrent-masking feature in accordance with an aspect of the subject system. Although, three redundant circuits, 602-606, are illustrated in FIG. 6, it can be appreciated that the subject disclosure is not so limited and most any number (N) of redundant circuits can be employed. In particular, the detection circuit and/or the overcurrent shut-off circuit utilized in circuits 602-606 to provide a positive transient detector, can be implemented by circuits 200, 300 and/or 400. Moreover, on disconnection of one of the loads 110_{1-N}, system 600 prevents erogenous disconnection of the remaining loads, and thus eliminates costly downtime. As an example system 600 can be utilized in a server (e.g., telecommunication server), wherein load 110 can be a disk array.

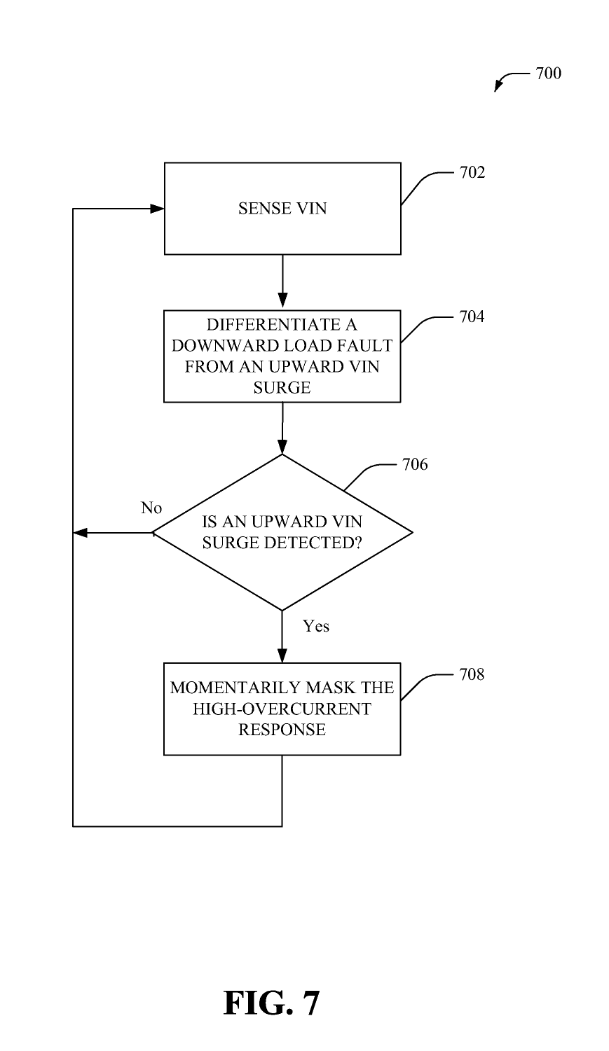

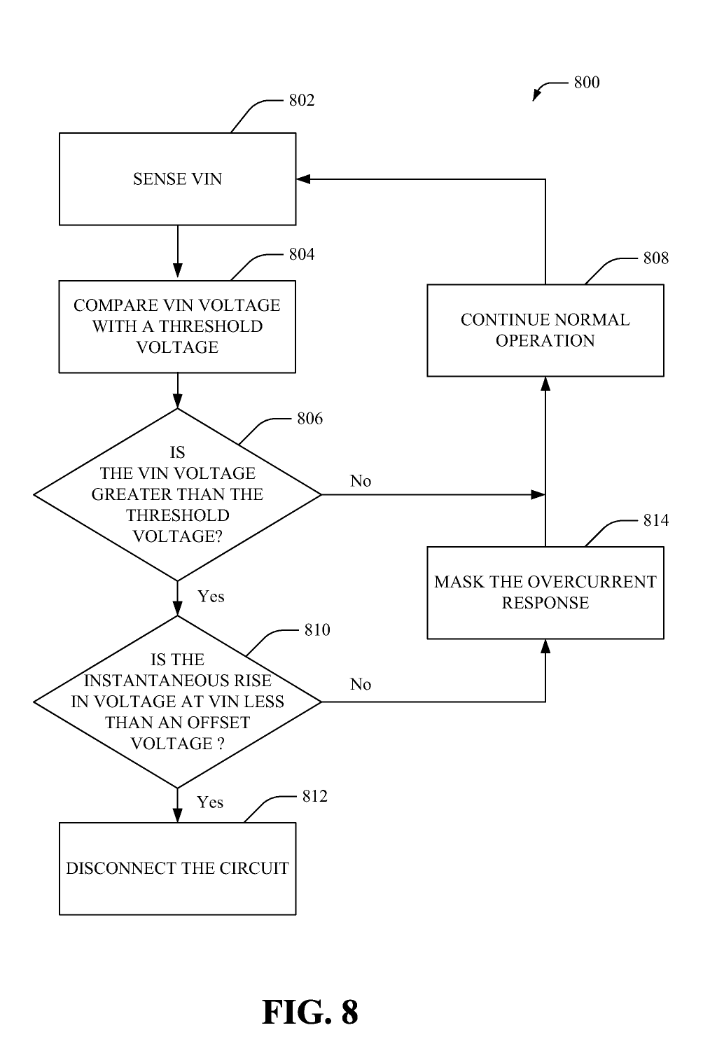

FIGS. 7-8 illustrate methodologies and/or flow diagrams in accordance with the disclosed subject matter. For simplicity of explanation, the methodologies are depicted and described as a series of acts. It is to be understood and appreciated that the embodiments of the subject innovation are not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, it is to be appreciated that the methodologies could alternatively be represented as a series of interrelated states via a state diagram or events. Additionally, the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device or storage media.

Referring to FIG. 7 there illustrated is a methodology 700 for identifying a true fault condition in circuit breakers, according to an aspect of the subject disclosure. As an example, methodology 700 can be utilized in various hot plug circuit break applications, such as, but not limited to, distributed power systems, high availability servers, disk arrays, powered insertion boards, etc. Moreover, methodology 700 facilitates differentiation between overload conditions caused by spikes/surges in supply voltage and overload conditions caused by faulty loads.

At 702, input voltage VIN (e.g., power supply voltage) can be sensed. In general, VIN voltage can be sensed directly or voltage (VIN_related) at a sense node can be sensed. Generally, the sense node is preferred over the VIN supply pin, if the VIN supply pin has external filtering that can degrade the VIN signal. At 704, a downward load fault can be differentiated from an upward VIN surge. As an example, a high pass filter (e.g., described in detail with respect to FIGS. 2, 3, 4 and 5) can be employed to identify an upward VIN surge. Furthermore, at 706, it is determined whether the upward VIN surge is identified. As an example, with respect to circuits 200 and 300, when an upward VIN surge appears, at VIN, an instantaneous voltage offset replica appears at a non-inverting input of a secondary comparator, causing it to trip and output a HIGH signal to the OR gate. If the upward VIN surge is identified, then, at 708, the overcurrent response is masked. Alternately, if the upward VIN surge is not identified and a downward load fault is detected, the overcurrent circuit can be activated and the circuit can be disabled/deactivated.

FIG. 8 illustrates an example methodology 800 for accurately disconnecting a circuit on identifying a true fault condition in accordance with an aspect of the subject disclosure. At 802, input supply voltage (VIN) can be sensed. As an example, VIN voltage can be sensed directly at the input voltage supply pin or voltage (VIN_related) at a sense node can be sensed. Oftentimes, the sense node is preferred over the VIN supply pin, if the VIN supply pin has external filtering, which can degrade the VIN signal. At 804, the sensed voltage (e.g., VIN or VIN_related) can be compared with a threshold voltage. For example, the threshold voltage can be most any predefined outer bounds voltage, e.g., 50-100 mV, indicative of the allowable limit for overcurrent.

At 806, it can be determined whether the sensed voltage is greater than the threshold voltage (V). If the sensed voltage is not greater than the threshold voltage, then at 808, normal operation can continue (e.g., without disconnecting the circuit) and the methodology 800 can continue to sense the input voltage at 802. Typically, on failure of the load, for example, if the load is short-circuited, the sensed voltage across a sense resistor or sensed voltage at a sense node, can substantially increase and become larger than the threshold voltage. In addition, voltage spikes/surges in the supply voltage can also cause the sensed voltage to increase beyond the threshold voltage. Accordingly, if the sensed voltage is greater than the threshold voltage, then at 810, it is determined whether an instantaneous rise in voltage (δv) at VIN (or VIN_related) is less than an offset voltage (V_{os fix}). As an example, the offset voltage can be a predefined fixed voltage that compensates for noise and/or a negative offset voltage (e.g., due to faulty load).

If the instantaneous rise in voltage (δv) is less than the offset voltage, then it can be determined that the overcurrent is caused by a faulty load. Accordingly, at 812, the circuit (e.g., including the faulty load) can be disconnected. Alternately, if the instantaneous rise in voltage (δv) is not less than the offset voltage, then it can be determined that the overcurrent is caused by an upward spike/surge and/or poor voltage regulation in supply voltage. In this case, a large positive current will pass harmlessly into the load capacitors. Moreover, since the overload in this case is not caused by a faulty load, it is inappropriate to shut-off the load. Thus if the instantaneous rise in voltage (δv) is not less than the offset voltage, then at 814, the overcurrent response (e.g., to disconnect the circuit) can be momentarily/temporarily masked. For example, a disable signal can be generated to momentarily/temporarily disable an overcurrent response circuit that disconnects a circuit (e.g., including the load) on detection of an overload condition. After masking the overcurrent response, at 808, normal operation (e.g., without disconnecting the circuit) can be continued and at 802, supply voltage (VIN or VIN_related) can continued to be sensed.

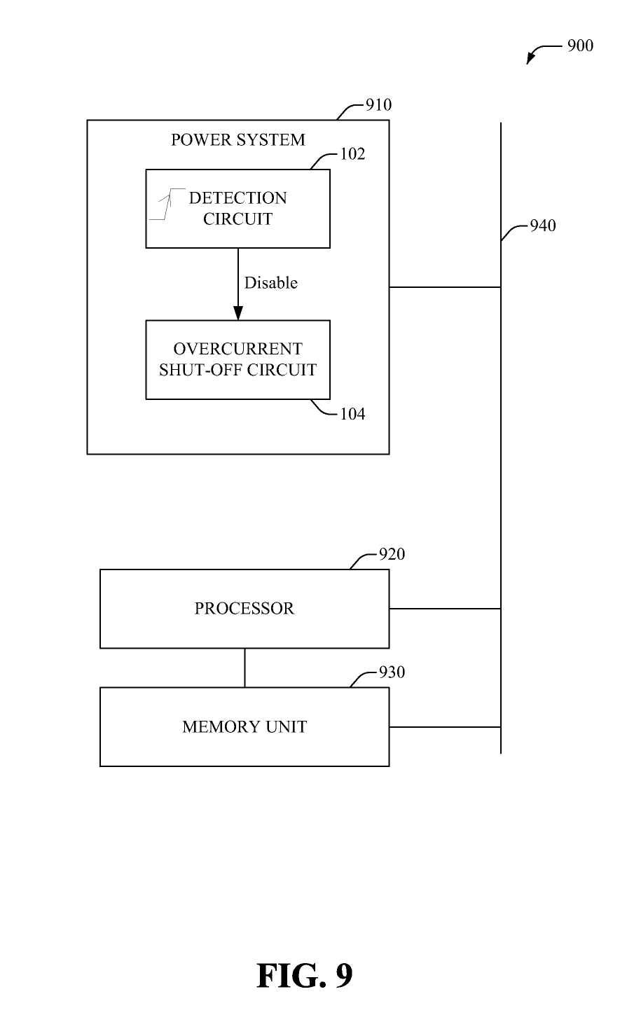

FIG. 9 is a block diagram of an electronic system 900 that includes at least one power system 910 that includes a detection circuit 102 and an overrcurrent shut-off circuit 104, described in the foregoing embodiments. The power system 910 is electrically coupled to at least one processor 920 and at least one memory unit 930. For example, a bus 940 can provide electrical connections between power system 910, processor 920, and memory unit 930. The processor 920 and memory unit 930 are also electrically coupled to each other.

Typically, the memory unit 930 can include volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory (e.g., data stores, databases, caches) of the subject systems and methods is intended to comprise, without being limited to, these and any other suitable types of memory.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

The components and circuitry elements described above can be of any suitable value in order to implement the embodiments of the present invention. For example, the resistors can be of any suitable resistance, amplifiers can provide any suitable gain, current sources can provide any suitable amperage, etc. The resistors and capacitors can be of any suitable value and/or have any particular ratios between one another. Furthermore, the amplifiers can include any suitable gain.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An apparatus, comprising:
a detector for sensing a signal related to a supply voltage; and
an overcurrent shut-off circuit that facilitates disconnection of a load from the supply voltage; wherein,
the detector for generating an output signal in response to a positive voltage surge on the supply voltage; and
the output signal for disabling the overcurrent shut-off circuit.

2. The apparatus of claim 1, wherein the overcurrent shut-off circuit comprises:
a first comparator with a first input coupled to the supply voltage and a second input coupled to a predefined voltage threshold; and
a logic gate with a first input coupled to an output of the first comparator and a second input coupled to the output signal.

3. The apparatus of claim 2, wherein the overcurrent shut-off circuit includes a latch with a reset input coupled to an output of the logic gate, and an output coupled to a control pin of a switch for disconnecting a load.

4. The apparatus of claim 2, further comprising: a switch for connecting the supply voltage and a load, wherein an output of the logic gate controls the switch.

5. The apparatus of claim 4, wherein the switch includes an n-channel metal-oxide-semiconductor field-effect transistor (n-MOSFET).

6. The apparatus of claim 1, wherein the detector comprises:
a high pass filter; and
a second comparator with a first input coupled to an output of the high pass filter and a second input coupled to an offset voltage.

7. The apparatus of claim 6, wherein the high pass filter includes a capacitor connected between the supply voltage and a reference voltage.

8. The apparatus of claim 6, wherein the high pass filter includes a capacitor connected between a sense node and a reference voltage.

9. The apparatus of claim 1, wherein the detector includes a forward biased diode connected between the supply voltage and an input of a high pass filter.

10. The apparatus of claim 9, wherein the overcurrent shut-off circuit includes a first comparator with a first input coupled to a sense node and a second input coupled to an output of the high pass filter.

11. The apparatus of claim 10, wherein the overcurrent shut-off circuit includes a latch with a reset input coupled to an output of the first comparator and an output coupled to a control pin of a switch for disconnecting a load.

12. The apparatus of claim 10, wherein an output of the first comparator is coupled to a control pin of a switch for disconnecting a load.

13. A method, comprising:
identifying an overcurrent condition generated by a positive spike in supply voltage;
confirming that the overcurrent condition is not caused due to a negative spike in the supply voltage; and
preventing disconnection of a load in response to the confirming.

14. The method of claim 13, further comprising: sensing a voltage at, at least one of, a supply voltage pin or a sense node to facilitate the identifying.

15. The method of claim 14, wherein the identifying includes comparing the voltage with a predefined threshold voltage for detecting the positive spike.

16. The method of claim 15, further comprising:
comparing an instantaneous rise in the voltage with an offset voltage, if the voltage is greater than the predefined threshold voltage; and
preventing a response that disconnects the load, if the instantaneous rise in the voltage is greater than the offset voltage.

17. The method of claim 13, wherein the indentifying includes differentiating between an overcurrent caused by a fault in the load and an overcurrent caused by the positive spike in supply voltage.

18. A redundant power system, comprising:
at least two redundant circuits connected in parallel, each including a positive transient detector coupled to an overcurrent shut-off circuit for disconnecting a load during overload,
wherein a first positive transient detector of a first redundant circuit disables a first overcurrent shut-off circuit of the first redundant circuit, in response to disconnection of a second redundant circuit by a second overcurrent shut-off circuit of the second redundant circuit.

19. The redundant power system of claim 18, wherein a second positive transient detector of the second redundant circuit discriminates at least one of a positive surge voltage, a positive spike voltage or poor voltage regulation on a supply voltage of the second redundant circuit, from a load voltage collapse in the second redundant circuit, and facilitates the disconnection in response to the load voltage collapse.

20. The redundant power system of claim 18, wherein the first positive transient detector senses a first voltage signal supplied to a first load, the first overcurrent shut-off circuit facilitates disconnection of the first load from the first voltage signal, on detecting an overcurrent condition, and wherein first positive transient detector masks the overcurrent condition in response to identifying a positive spike in the first voltage signal.
